(19) United States
(12) Patent Application Publication
(10) Pub. No.: US 2024/0083292 A1
(43) Pub. Date: Mar. 14, 2024

(54) ELECTRIC VEHICLE CHARGING SYSTEMS WITH DOCKING STATIONS

(71) Applicant: SparkCharge, Inc., Somerville, MA (US)

(72) Inventors: Rifat Alam SIDDIQUE, Waltham, MA (US); Daniel JANOWIEC, South Boston, MA (US)

(73) Assignee: SparkCharge, Inc., Somerville, MA (US)

(21) Appl. No.: 18/466,282

(22) Filed: Sep. 13, 2023

Related U.S. Application Data
(60) Provisional application No. 63/375,635, filed on Sep. 14, 2022.

(51) Int. Cl. B60L 53/80; B60L 53/10; B60L 53/30; B60L 53/60

(52) U.S. Cl. CPC B60L 53/80; B60L 53/11; B60L 53/30; B60L 53/60

(57) ABSTRACT

Electric vehicle charging systems and methods are provided, which include an energy storage unit and a docking station sized to accommodate the energy storage unit within the docking station in a docked position. The docking station includes an energy storage docking receptacle to operatively couple the energy storage unit to the docking station in the docked position. The electric vehicle charging system facilitates charging an electric vehicle battery.

### BACKGROUND

Rechargeable batteries have been used for electrical energy storage in a wide variety of applications, including in electric vehicles. Electric vehicles that use rechargeable batteries can include a variety of types of electric vehicles, hybrid electric vehicles, boats, aircrafts, golf carts, etc. Electric chargers and methods of charging electric vehicles have been developed and used for charging rechargeable batteries of the electric vehicles. The chargers are conventionally installed stationary chargers that use power from the electric power grid.

### SUMMARY

Shortcomings of the prior art are overcome, and additional advantages are provided through the provision, in one or more aspects, of an electric vehicle charging system, which includes an energy storage unit, and a docking station sized to accommodate the energy storage unit therein in a docked position. The docking station includes an energy storage docking receptacle to operatively couple the energy storage unit to the docking station in the docked position. In one aspect, the electric vehicle charging station facilitates charging an electric vehicle battery.

In one or more other aspects, an electric vehicle charging system is provided, which includes multiple energy storage units, a charger unit, and a docking station. The docking station is sized to accommodate the multiple energy storage units and the charger unit, each in a respective docked position within the docking station. Further, the docking station includes multiple energy storage docking receptacles to operatively couple respective energy storage units of the multiple energy storage units to the docking station in the docked position, and a charger docking receptacle to operatively couple the charger unit to the docking station in the docked position. In operation, the electric vehicle charging system facilitates, at least in part, charging an electric vehicle battery.

In one or more further aspects, an electric vehicle charging system is provided, which includes multiple energy storage units, multiple DC charger units, and a docking station. The docking station is sized to accommodate the multiple energy storage units and the multiple DC charger units, each in a respective docked position within the docking station, and the docking station is a container-type docking station. The docking station includes multiple energy storage docking receptacles to operatively couple respective energy storage units of the multiple energy storage units to the docking station in the docked position, and multiple charger docking receptacles to operatively couple respective DC charger units of the multiple DC charger units to the docking station in the docked position. In operation, the electric vehicle charging system facilitates, at least in part, charging the electric vehicle battery.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1A depicts one embodiment of a docking station of an electric vehicle charging system, in accordance with one or more aspects of the present invention;

FIG. 1B depicts a rotated view of the docking station embodiment of FIG. 1A of an electric vehicle charging system, in accordance with one or more aspects of the present invention;

FIG. 2 is a schematic of one embodiment of an electric vehicle charging system, in accordance with one or more aspects of the present invention;

FIG. 3 is a schematic of another embodiment of an electric vehicle charging system, in accordance with one or more aspects of the present invention;

FIGS. 4A-4C depict further embodiments of an electric vehicle charging system, in accordance with one or more aspects of the present invention;

FIG. 5 depicts one embodiment of a workflow of an electric vehicle charging system, in accordance with one or more aspects of the present invention;

FIG. 6A depicts another embodiment of a docking station of an electric vehicle charging system, in accordance with one or more aspects of the present invention;

FIG. 6B is an end elevational view of the docking station embodiment of FIG. 6A, in accordance with one or more aspects of the present invention;

FIG. 7 depicts one embodiment of a safety monitoring system for a docking station of an electric vehicle charging system, in accordance with one or more aspects of the present invention; and

FIG. 8 depicts an example of a computing environment or control to incorporate and use one or more aspects of the present invention.

### DETAILED DESCRIPTION

The accompanying figures, which are incorporated in and form a part of this specification, further illustrate the present invention and, together with this detailed description of the invention, serve to explain aspects of the present invention. Note in this regard that descriptions of well-known systems, devices, processing techniques, etc., are omitted so as to not unnecessarily obscure the invention in detail. It should be understood, however, that the detailed description and this specific example(s), while indicating aspects of the invention, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed herein.

Note also that illustrative embodiments are described below using specific code, designs, architectures, protocols, layouts, schematics, or tools only as examples, and not by way of limitation. Furthermore, the illustrative embodiments are described in certain instances using particular hardware, software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

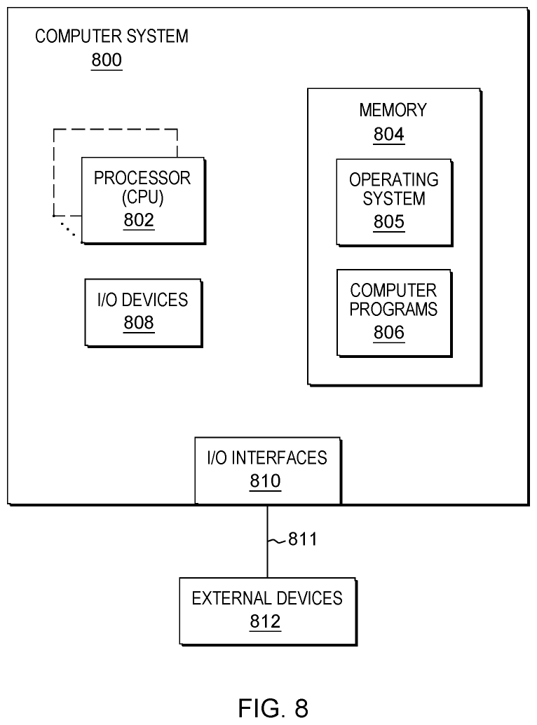

As understood by one skilled in the art, control program code, as referred to in this application, can include both software and hardware. For example, control program code in certain embodiments of the present invention can utilize a software-based implementation of certain functions described, while other embodiments can include (at least in part) fixed function hardware. Certain embodiments can combine both types of program code. Examples of control program code, also referred to as one or more programs, are depicted in FIG. 8 as computer programs 806, which are illustrated by way of example only.

In one or more embodiments, described herein are electric vehicle (EV) charging system for charging an EV battery. The EV charging system(s) can provide unidirectional or bidirectional flow of an electric charge using, for instance, alternating current-to-direct-current (AC-DC) conversion and/or direct-current-to-direct-current (DC-DC) conversion, where the electric input is received from an AC power source and/or DC energy source. In one or more implementations, the DC energy source can be one or more swappable, portable energy storage units. In one implementation, the electric charge can be transmitted, via the EV charging system, to the EV battery. According to various embodiments, the EV charging system can provide an output of a constant current (CC) or a constant voltage (CV) across a wide DC voltage output range to the EV battery.

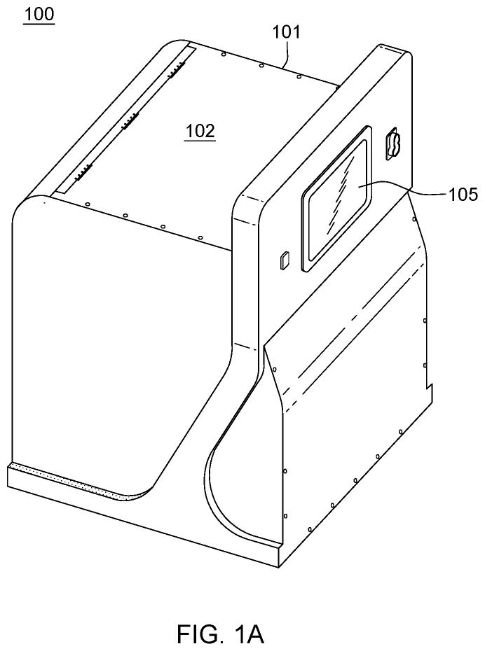

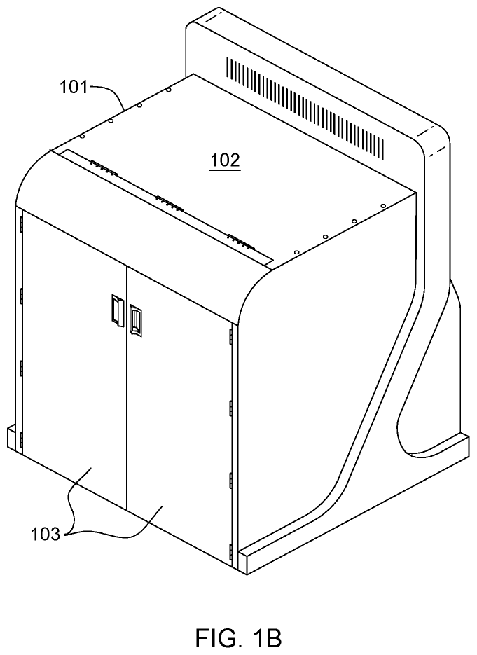

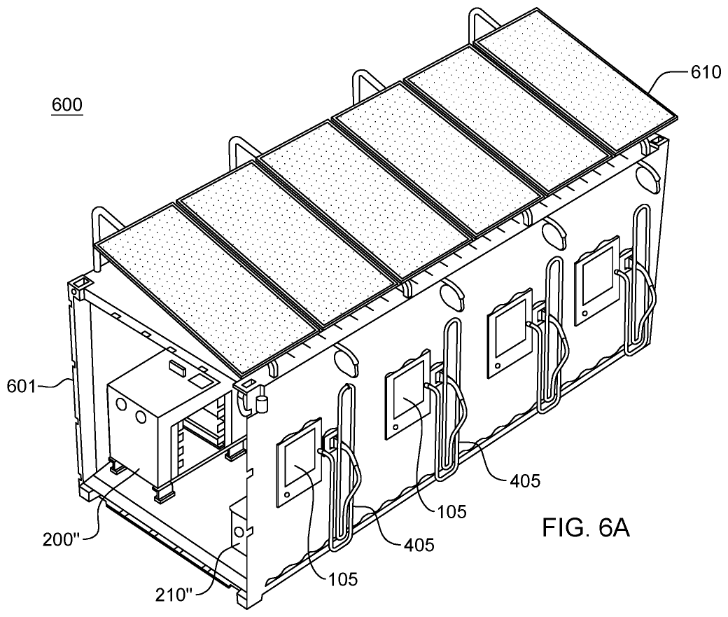

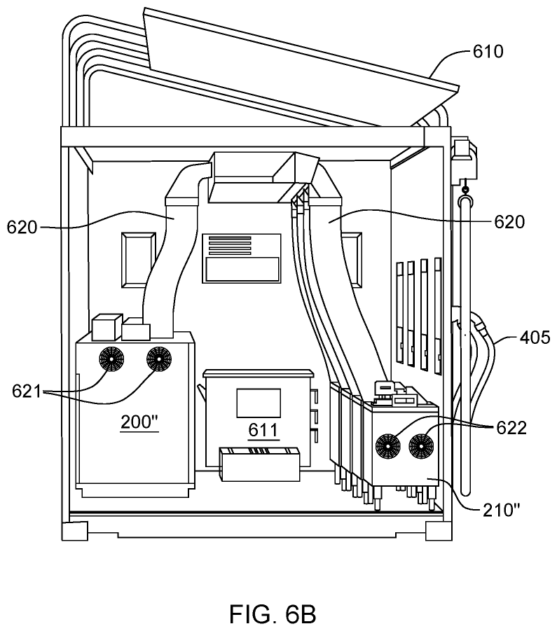

In one or more implementations, the electric vehicle (EV) charging systems disclosed herein include a docking station, exemplary embodiments of which are depicted in FIGS. 1A-4C, as well as FIGS. 6A-6B, by way of example only.

Referring to FIGS. 1A & 1B, docking station 101 of electric vehicle charging system 100 includes a housing 102 sized to accommodate, in one or more implementations, one or more energy storage units therein in a docked position. In one or more implementations, the energy storage unit is a DC energy storage unit which can be charged, or swapped out, depending on the implementation, and availability of electric charge. In one or more implementations, housing 102 of docking station 101 is a weatherproof enclosure sized to house components of electric vehicle charging system 100. In one or more implementations, certain of these components can be portable components including, in one or more embodiments, the energy storage unit(s) and one or more charger units, such as a DC charger unit. In one or more implementations, the energy storage unit(s) can be one or more swappable, portable energy storage units, and the charger unit can be one or more swappable, portable charger units. In one or more embodiments, housing 102 of docking station 101 can be sized to accommodate multiple energy storage units in docked position therein, as well as one or more charger units in docked position. In one embodiment, doors 103 can be provided in housing 102 of docking station 101 to facilitate, for instance, docking or removal of a portable energy storage unit and/or a portable charger unit from the docking station.

Advantageously, housing 102 further includes, in one or more embodiments, a user interface, such as a display screen 105 associated with a computer control of electric vehicle charging system 100. One or more user input mechanisms can be provided to allow, for instance, user control of electric charging via the electric vehicle charging system. In one or more intelligent docking station implementations, user interface display screen 105, and the one or more user input mechanisms, can be used to allow the user to communicate with the system via, for instance, one or more applications.

As noted, in one or more implementations, docking station 101 of electric vehicle (EV) charging system 100 includes one or more doors, such as rear doors 103, which are sized to allow an operator to dock and/or remove, for instance, an energy storage unit and/or charger unit, such as described herein. The units docked can be locked internally, such as via an electro-mechanical locking mechanism, and the door(s) can also be locked. As noted, in one or more implementations, docking station 101 is weatherproof, being a full enclosure, and is able to vent heat without risk of water entering into the docking station. Another feature of the docking station embodiment of FIGS. 1A & 1B is that is can include, for instance, a computer system, with a user interface or display screen 105 that is able to report parameters of the charging system, while, for example, also allowing a user connectivity to a third party application programming interface (API), to provide a complete interactive charging experience for the user.

In one or more implementations, docking station 101 can be a grid-less docking station, with no connection, for instance, to an AC power source, while in one or more other embodiments, docking station 101 can include connection to an AC power source, such as an underground electrical connection to an AC power grid.

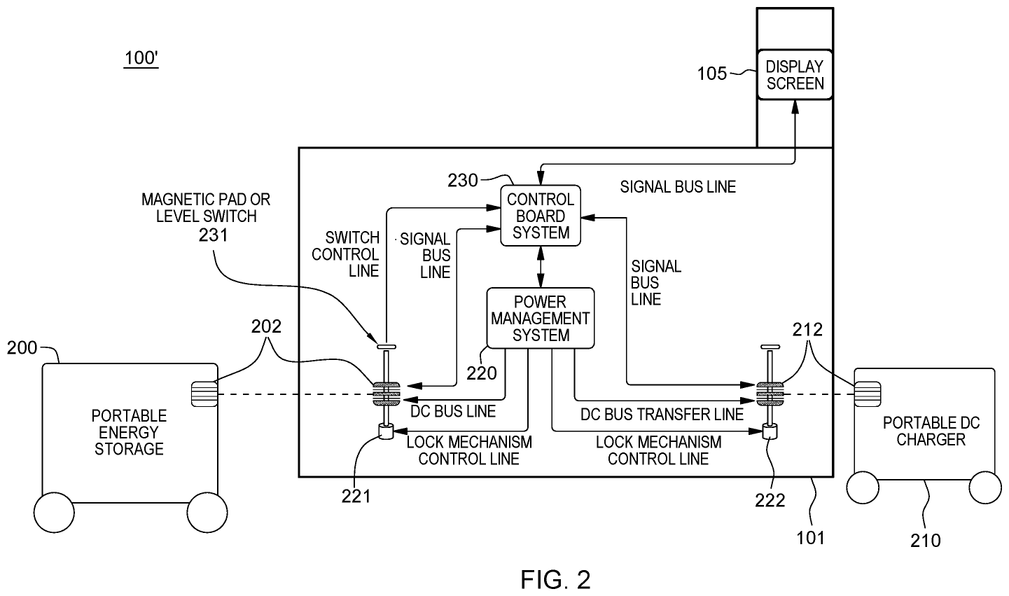

FIG. 2 depicts one embodiment of an electric vehicle charging system 100′, such as electric vehicle charging system 100 of FIGS. 1A-1B, with docking station 101 configured as a grid-less docking station, and the docking station being self-contained to charge, for instance, an electric vehicle (EV) battery. As noted herein, this represents one embodiment only of an electric vehicle charging system, in accordance with one or more aspects of the present invention.

As illustrated in FIG. 2, docking station 101 and one or more portable energy storage units 200 are sized, and configured with respective receptacles 202, that is, respective mechanical and electrical mating receptacles, to allow operative docking of one or more portable energy storage units within docking station 101, to operatively couple the energy storage unit(s) 200 to docking station 101. Similarly, docking station 101 is sized to accommodate one or more charger units 210, such as one or more DC portable charger units, which can similarly be operatively coupled to docking station 101 via respective mechanical and electrical mating receptacles 212.

In the embodiment illustrated, docking station 101 includes a control or controller which can include one or more boards including, for instance, a power management system or board 220 and a control board or control board system 230, in one example. Note that the implementation of FIG. 2 represents one embodiment only of the control. In one or more other embodiments, the control features described herein can be differently implemented on, for instance, a single board, or one or more other devices or systems.

In the embodiment illustrated, power management system 220 connects, for instance, a DC bus line and a DC bus transfer line within docking station 101 to facilitate charge transfer between energy storage unit 200 and charger unit 210 when the units are operatively docked within the docking station. To facilitate maintaining operative docking, interlock mechanisms 221, 222 are provided, such as solenoid or electro-mechanical lock mechanisms, which can be controlled via power management system 220, in one embodiment. The interlock mechanisms 221, 222, are provided in one or more implementations to ensure that energy storage unit 200 and charger unit 210 remain locked in position when docked and operatively coupled to docking station 101.

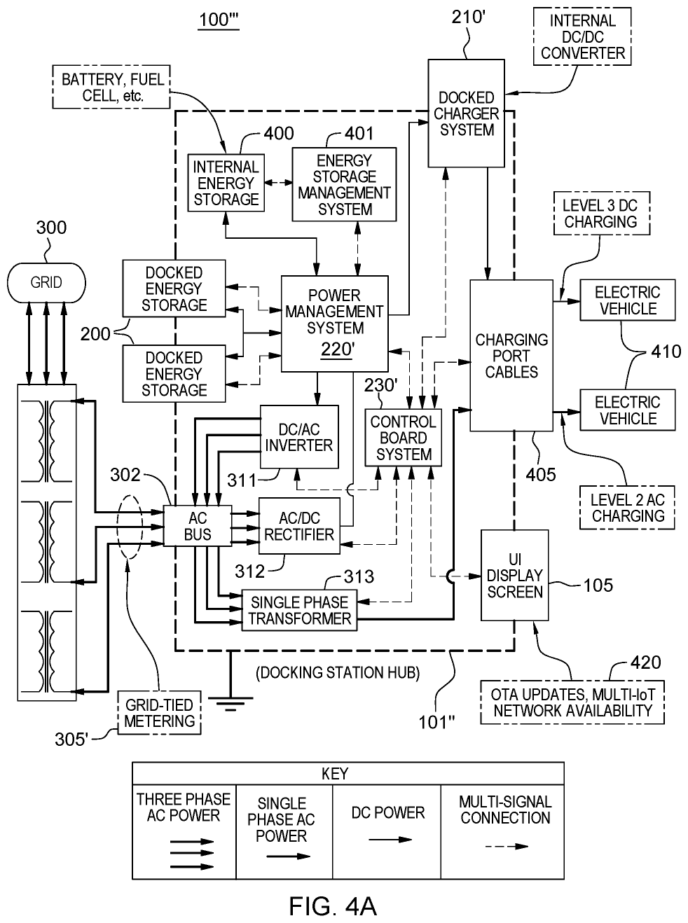

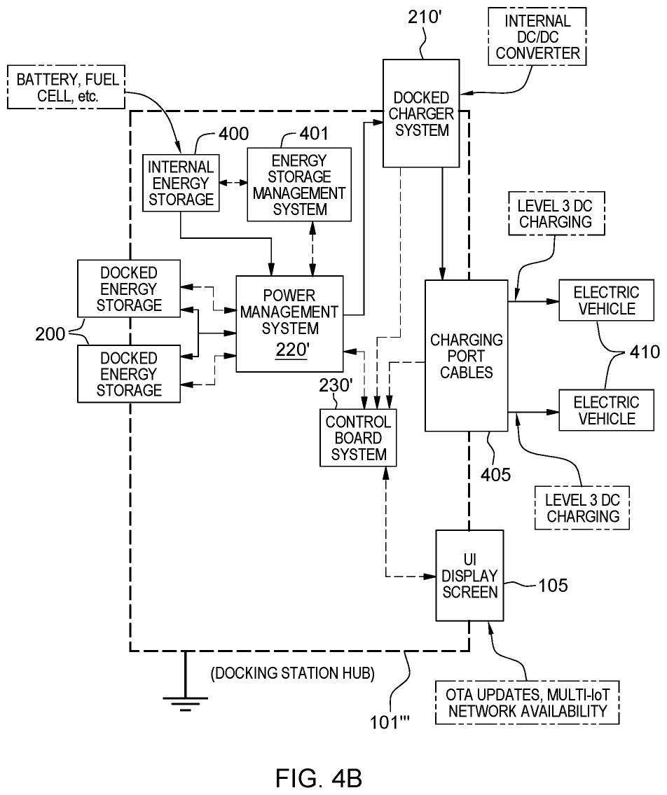

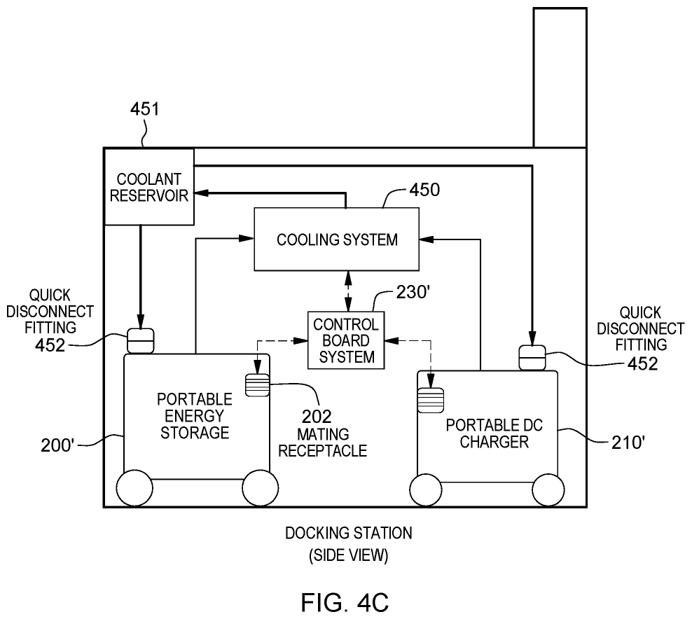

In one or more implementations, receptacles 202, 212 are configured to include power line couplings and signal line couplings, with the power lines coupling to the respective DC bus line and DC bus transfer line, and the signal lines coupling to respective signal bus lines connecting the receptacles to control board system 230. In one or more implementations, control board system 230 is also connected to user interface display screen 105, as well as to a switch control line, which can include a magnetic pad or level switch 231 for, for instance, automated shut-off of the electric vehicle charging system should, for instance, an issue with one or more aspects of the electric vehicle charging system be detected. In one or more embodiments, control board system 230 and/or power management system 220 include a control or controller with program code to control charging operations between docking station 101 and an electric vehicle (EV) battery via a cable assembly coupling the electric vehicle charging system to the electric vehicle (see FIGS. 4A-4B).

Those skilled in the art will note with reference to the embodiment of FIG. 2, that the docking station's interlock mechanisms allow one or more energy storage units and one or more charger units to dock within the docking station, and to be locked in a docked, operative position. In one or more embodiments, power management system 220 includes a control to check continuity across the DC power lines, and control board system 230 checks, via signal and communication lines with the receptacle couplings 202, 212, to ensure there is a proper electrical and mechanical connection before any high-power charge transfer occurs.

In operation, once energy storage unit(s) 200 and charger unit(s) 210 are safely docked and operatively coupled to docking station 101, a signal is sent to control board system 230 to provide power management system 220 access to close-in the DC bus line for power transfer to and/or from energy storage unit(s) 200, or to the charger unit(s) 210, from the energy storage unit. This action efficiently integrates the two units together within the electric vehicle charging system.

In one or more embodiments, to undock the energy storage unit 200, or charger unit 210, a service operator (or user) can provide information via user interface display screen 105 (e.g., authorization information and requests) to request undocking. Based on this input, power management system 220 is instructed to open the DC bus line, disrupting any power transfer, and to send a control signal to the control board, which will then signal interlock mechanism 221 to release the requested unit(s). At this point, the user can then safely remove the docked unit from the docking station, for instance, for swapping out the portable energy storage unit or portable DC charger unit from the docking station.

In one embodiment, the electric vehicle charging system controls can further include an energy storage control associated with portable energy storage unit(s) 200, as well as a power electronic control and a charging control (or controller) associated with charger unit 210. In one or more embodiments, charger unit 210 can also include power electronics controlled by, for instance, the power electronics control and charging controller of the unit. The power electronics can include, in one or more embodiments, a converter, such as an isolated, DC-DC converter (in one example only), configured to facilitate providing an electric charge to, for instance, an EV battery or other load from a power input, such as from portable energy storage unit(s) 200. The converter of the power electronics can be controlled by program code in the power electronics control and/or charging controller.

In one or more embodiments, the converter of the power electronics of the charger unit can include, for instance, an inrush current-limiting circuit to facilitate the electric vehicle charging system charging at a controlled rate when an electric vehicle load is electrically connected to the charging system. Advantageously, an inrush, current-limiting circuit can provide longer life expectancy and safer operation for the power components of the electric vehicle charging system. After the power passes through the inrush protection circuitry (e.g., inrush current-limiting circuit), the voltage can be bucked or boosted based on the electric vehicle load requirements. Note in this regard that, in one or more embodiments, multiple converters can be connected to operate in parallel to maintain the voltage on the output, and supply the current required by the load. In one or more embodiments, each DC-DC converter includes an electromagnetic interference (EMI) filter to inhibit transfer of noise to the load (e.g., electric vehicle battery). Note that it is also possible that external EMI filtering can be provided as well. In one or more implementations, after filtering the current, the current can also pass through unidirectional circuitry that, for instance, prevents an electric vehicle battery load from providing power-back (i.e., discharging) into the electric vehicle charging system. Advantageously, in one implementation, unidirectional current circuitry can ensure that power is only being provided to, for instance, the EV battery, and does not remove power from the EV battery. However, in one or more other embodiments, the unidirectional current circuitry can be omitted from the modular electric vehicle charging system, if desired, to facilitate, for instance, one or more features described herein.

In one or more embodiments, the power electronics control and/or charging controller of the charger unit can include electronic control circuitry, or control code, that controls the converter of the power electronics. Additionally, these controllers can include vehicle communication circuitry that is configured to establish charging protocols between, for instance, the control system and the EV battery. Note that, in one or more other embodiments, bidirectional current circuitry can be provided within the power electronics of the charger unit to allow selective charging of the load by the electric vehicle charging system, or charging of the portable energy storage unit from the load, such as an electric vehicle battery, or another power source, if desired.

Advantageously, electric vehicle (EV) charging system 100′ of FIG. 2, and in particular, docking station 101, includes an interlock mechanism which allows one or more energy storage units and one or more charger units (or charger systems) to be operatively docked and locked within the docking station safely. In one embodiment, power management system 220 checks continuity across the DC power lines, and control board system 230 checks signal and communication lines to ensure proper electromechanical docking of the respective units has occurred before high-power transfer proceeds. Once the units are operatively docked and locked within the docking station, a signal is sent to control board system 230 to provide power management system 220 access to “close in” the DC bus line for power transfer to and from the energy storage unit, or to the docked charger unit from the energy storage unit. This action integrates the systems together. To undock the energy storage unit and/or charger unit, a service operator or user can provide information via user interface display screen 105 to request undocking. As this occurs, power management system 220 will “open in” the DC bus line, disrupting any power transfer, and also send a control signal to control board system 230, after which a signal is sent to the locking mechanism to release one or more of the energy storage unit(s) or charger unit(s). The operator is then able to safely remove the desired docked unit from the docking station. Note that although shown as part of docking station 101 in the embodiment of FIG. 2, power management system 220 can alternatively be part of the portable DC charger 210, in one or more other embodiments.

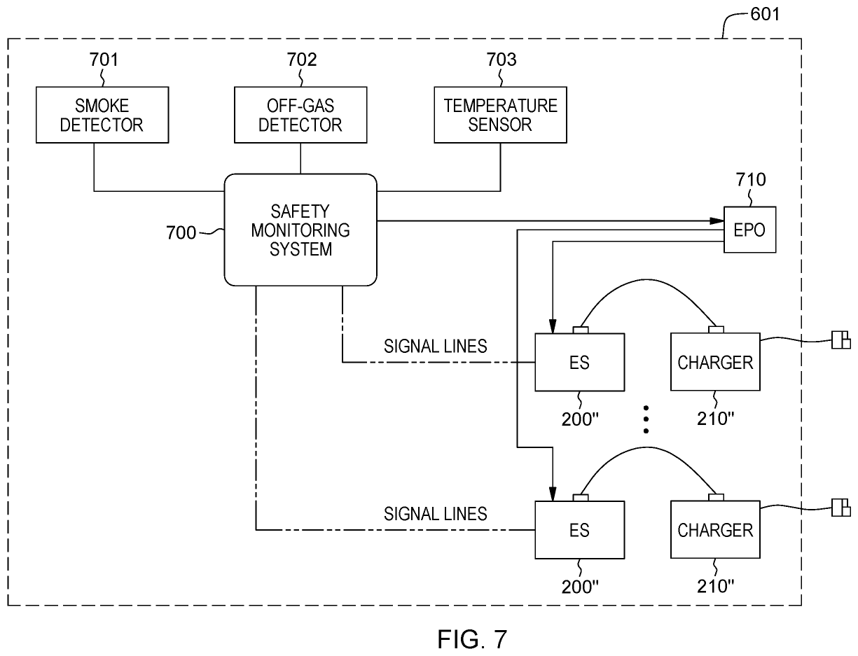

As described further below with reference to FIG. 7, docking station 101 can further include a safety monitoring system, such as safety monitoring system 700 (FIG. 7), to monitor the electric vehicle charging system, including docking station 101, for a potential fault. For instance, in one or more embodiments, the safety monitoring system can be operatively coupled to one or more detectors and/or sensors disposed within the docking station, or even external to the docking station. In the embodiment of FIG. 7, the safety monitoring system is operatively coupled to one or more smoke detectors, one or more off-gas detectors, and one or more temperature sensors, by way of example only. In one or more implementations, the safety monitoring system is operatively coupled to one or more components of the electric vehicle charging system to communicate with the one or more components, such as to collect status of one or more components or systems within the docking station to detect any of a variety of potential faults. If a fault is triggered, for instance, an over-temperature condition inside the docking station, then the safety monitoring system can automatically shut down one or more systems or components within the docking station as needed, based on the detected fault condition. In one embodiment, an emergency power-OFF (EPO) is provided as part of the electric vehicle charging system to, for instance, shut down and/or disconnect the one or more components or systems, such as portable energy storage unit 200, and/or portable DC charger unit 210.

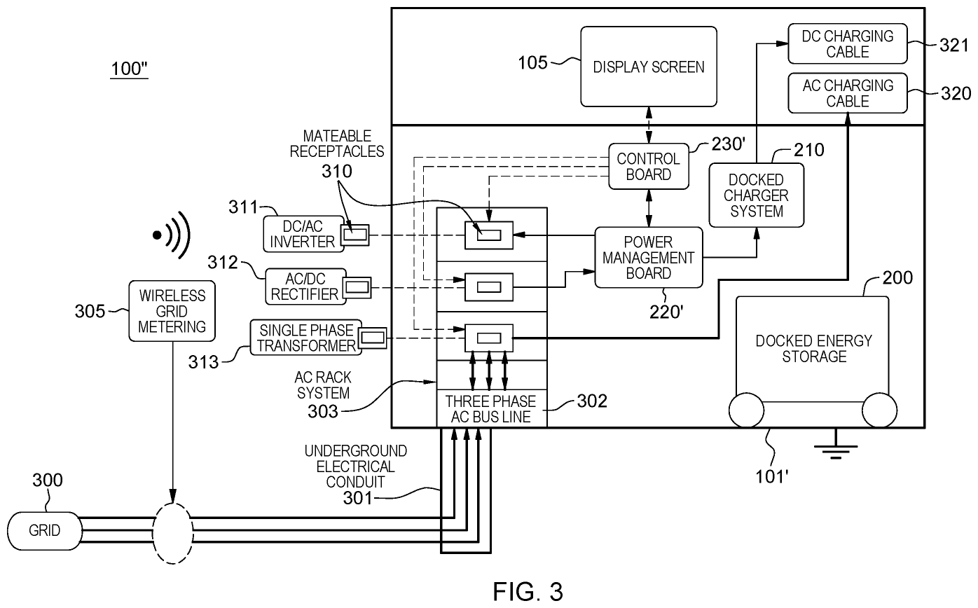

FIG. 3 is a schematic of another embodiment of an electric vehicle charging system 100″, in accordance with one or more aspects of the present invention. In one or more implementations, electric vehicle charging system 100″ can include a docking station 101′, similar to docking station 101 described above in connection with FIGS. 1A-2. In this implementation, docking station 101′ is configured with an alternating current (AC) integration feature, that allows the electric vehicle (EV) charging system to have installed and/or swapped out, AC power electronics via respective mateable receptacles 310. In the implementation depicted, the AC integration feature utilizes a rack-type system 303 that connects directly to a three-phase AC bus line (or conduit) 301 tied to an AC power source 300, such as an AC power grid. In one embodiment, each level of the AC rack system 303 includes a mateable receptacle with hard-wired/bus connections to a respective power line and control signaling. In one embodiment, power metering can occur on the AC side via a wireless grid meter 305 that communicates to, for instance, the user and the docking station. Metering can also occur on the power management board and AC charging end to ensure charge parameters are monitored and within set limits. In one or more embodiment, meter data can be accessed via the user interface display screen 105.

In one or more embodiments, control board 230′ senses the integration of the AC electronics in order to control the opening and closing of power lines, and updating of the electric vehicle charging system's configuration. In the embodiment depicted, the three-phase AC bus line 302 is connected to AC rack system 303, which couples to one or more swappable, single-phase transformers 313, as well as to an insertable and/or swappable DC/AC inverter(s) 311, and AC/DC rectifier(s) 312. In one embodiment, power management board 220′ interfaces with and senses the presence of DC/AC inverter(s) 311 and AC/DC rectifier(s) 312. Note in this regard that, in one or more embodiments, docking station 101′ of electric vehicle charging system 100″ can be operational at a desired location for a period of time as a DC energy charger before the connection of the docking station to the AC power source, if desired.

In one embodiment, power metering can occur on the input AC side via a wireless grid meter 305′ that communicates to the user, and the docking station. Metering can also occur on the power management board and AC charging end to ensure charge parameters are monitored and within set limits. Meter data can also be accessed via the user interface 105 of docking station 101′, in one embodiment. An AC charging cable (or cable assembly) 320 is provided to couple electric vehicle charging system to a load, such as an electric vehicle battery. In the embodiment depicted, the AC grid-wiring 301 of docking station 101′ is assumed installed underground (in one embodiment), and installed per electrical code standards.

In the embodiment of FIG. 3, electric vehicle (EV) charging system 100″ further includes a docked charger unit or system 210 to allow, for instance, DC charging of an electric vehicle battery via DC charging cable 321, with DC power being obtained, in one embodiment, via AC/DC rectifier 312. In one or more other implementations, power can be supplied back to docketed energy storage unit 200 from an electrical vehicle battery or back to the AC power grid from the electric vehicle battery, via DC/AC inverter 311, such as during periods of high power demand on the grid.

FIG. 4A depicts a more detailed schematic of another embodiment of an electric vehicle charging system 100′″, in accordance with one or more aspects of the present invention. As indicated, electric vehicle charging system 100′″ of FIG. 4A is similar to electric vehicle charging system 100″ of FIG. 3, as well as, in part, electric vehicle charging system 100′ of FIG. 2, and electric vehicle charging system 100 of FIGS. 1A-1B. In this embodiment, docking station 101″ (or docking station hub) can be an enclosure, similar to that described above in connection with docking station 101 of FIGS. 1A-1B, and can include room for the various components illustrated in FIG. 4A. In the embodiment of FIG. 4A, electric vehicle charging system 100′″ is a power system that can use interchangeably grid-sourced electric energy, via an AC bus connection 302 to grid 300, or stored DC energy, via one or more docked energy storage units 200, and/or one more internal energy storage units 400 configured as part of docking station 101″. In one embodiment, electric vehicle charging system 100′″ can use both grid-sourced energy and DC-stored energy to, for instance, simultaneously charge one or more electric vehicles 410 at the same or different DC charge levels via respective charging port cables 405, as illustrated. In the embodiment illustrated, one electric vehicle (EV) battery undergoes Level-2 AC charging commensurate with another EV battery undergoing Level-3 DC charging, as one example. In this example, power management system 220′ and control board system 230′ can control AC-sourced charging from AC bus 302 via single-phase transformer(s) 313 and the respective charging port cable to charge an electric vehicle battery using AC charging, and can simultaneously facilitate DC charging from one or more docked energy storage units 200 and/or from internal energy storage 400, via a docked DC charger unit or system 210′ with internal DC-DC converter to allow DC charging of another electric vehicle battery. Electric vehicle charging system 100′″ further includes one or more DC/AC inverter(s) 311 and one or more AC/DC rectifier(s) 312, such as in the electric vehicle charging system 100″ embodiment of FIG. 3, described above. In the embodiment depicted in FIG. 4A, an energy storage management system 401 is provided to facilitate control of DC energy storage, including internal energy storage 400, which as illustrated, can include one or more batteries, fuel cells, etc. In one or more embodiments, OTA updates, and multi-Internet-of-Things (IoT) network capability 420 can also be provided in association with docking station 101″ via, for instance, docking station computer control, with one or more parameters or monitored variables being displayable via user interface display screen 105.

FIG. 4B depicts a further embodiment of a docking station 101′″, similar to docking station 101″ of FIG. 4A, without the integration of AC-sourced charging. Docking station 101′″ thus provides, in one embodiment, DC-to-DC charging of one or more electric vehicles (EV) 410 via one or more charging port cables 405. In the embodiment illustrated, simultaneous Level 3 DC charging of two or more electric vehicle batteries can occur.

FIG. 4B is a grid-less docking station, with ability to integrate one or more energy storage units, as well as DC power electronics, to be able to DC-fast-charge one or more electric vehicles, or electric vehicle batteries. The power management system 220′ and control board system 230′ facilitate this process. In one embodiment, power management system 220′ is programmed to configure, maintain and monitor power draw from multiple DC bus lines (as shown) to the docked charger unit or system 210′. Power management system 220′ accomplishes this by communicating with each power source via controller area network (CAN) protocol, or other form of signal communication, to manage how power should be drawn based on key parameters, such as available energy, state of charge (SOC), state of health (SOH), etc. As power management system 220′ is doing this, it is communicating with control board system 230′ to configure the DC power electronics in the docked charger unit or system to accept what power is available on the DC bus. Once the charger system is ready to accept power, power management system 220′ “joins in” the DC busses as one line, and gradually ramps power to the charger unit. As the charger system is taking in power, power management system 220′ is constantly monitoring the power and signal communication between sources, and updating the charger with any parameters that might change over time through control board 230′. The DC voltage is boosted or bucked within the charger system, as discussed herein, to the electric vehicle battery voltage, and the power is delivered to the vehicle battery via the charging port cable(s) 405.

In addition to acting as the intelligence unit or computer-implemented control for the docking station, control board system 230′ can provide a user with critical parameters within the system, while also allowing the user to choose how much power (or miles) are to be delivered to their vehicle, based on the availability of energy in the docking station. This value is transferred to the power management system 220′ and the charger unit to configure the system in the most efficient way of delivering the requested power (or miles). Another notable feature of control board system 230′ is that it can allow for bidirectional communication between the docking station, its power electronics, and the vehicle's control system that is plugged into the station for a charge. Note that this assumes that the charging port cables include both power lines and communication lines to allow the controls to communicate.

As noted in FIG. 4B, docking station 101′″ can include an energy storage management system 401 to facilitate control of DC energy storage, including energy storage in an internal energy storage unit 400, which as illustrated, can include one or more batteries, fuel cells, etc. In one or more embodiments, updates, and multi-Internet of Things (IoT) network capability can also be provided in association with docking station 101′″ via, for instance, docking station computer control, with one or more parameters or monitored variables being displayable by a user interface (UI) display screen 105.

FIG. 4C depicts another embodiment of an electric vehicle (EV) charging system, and docking station such as described herein, including the docking stations described with reference to FIGS. 2-4B, where one or more portable energy storage units 200′, such as portable energy storage units 200 described above in connection with FIG. 2, can be configured with one or more coolant loops to allow for the flow of a coolant, such as a liquid coolant, through the docked energy storage unit(s) 200′. Similarly, one or more portable DC charger units 210′, such as portable DC charger units 210 described herein in connection with FIG. 2, can be provided with one or more coolant-cooled loops within the charger unit that allow for a coolant to pass therethrough. With this configuration, cooling system 450 (or chiller) can be provided within the docking station to facilitate active cooling of one or more components of the docking station, including docked energy storage unit 200′ and docked DC charger unit 210′.

FIG. 4C illustrates one embodiment of integration of cooling system 450 into the docking station, and the flow of coolant between cooling system 450 and selected components within the docking station, including portable energy storage unit 200′ and portable DC charger unit 210′. In one or more implementations, cooling system 450 is a liquid-cooled cooling system, with heat being dispelled to the surrounding area via one or more air-cooled fins, or via a refrigerant of a chiller-cooled system, if desired. Cooling system 450 operates, for instance, to cool the energy storage unit(s), such as one or more lithium-ion battery packs after use, and/or to cool the high-power electronics within the docking station after or during use. A coolant reservoir 451 is also provided in fluid communication with cooling system 450 and the coolant loops within the one or more components of the docking station to be cooled, such as portable energy storage unit 200′ and portable DC charger unit 210′. The coolant loops can be coupled to cooling system 450 within the docking station via one or more respective quick disconnect fittings 452. In one or more embodiments, the cooling system components can include a chiller, or other heat exchange system, a control board, and the reservoir. As portable units are docked into the station, control signals are mated through the receptacles 202, and the coolant loops can be attached via the respective quick disconnect fittings. Control board system 230′ can act as the driver for cooling system 450, and will activate the system once (for instance) the docked units signal to be cooled based on specified thermal and/or temperature parameters. In one or more embodiments, coolant reservoir 451 can be positioned to be accessible for servicing by an operator when needed. Note that cooling system 450 being a liquid-cooled cooling system is one embodiment only. For instance, in one or more other embodiments, the cooling system can be, or include, forced-air-cooling of the portable DC charger or the portable energy storage, or both the portable DC charger and the portable energy storage.

Those skilled in the art will note that, provided herein are various embodiments of electric vehicle charging systems which utilize a docking station that accommodates, in part, one or more energy storage units, such as one or more swappable, portable energy storage units and/or internal energy storage units. In addition, in one or more embodiments, the charging system can be coupled to use grid-sourced energy in combination with, or as an alternative to, stored DC energy. The different energy sources can be used, in one embodiment, separately, or together, depending, for instance, on the number (and/or type) of electric vehicles to be charged, in one example.

In one or more embodiments, the docking station includes an electrical interlock system to mechanically and electrically dock and integrate a portable energy storage unit (e.g., battery, fuel cell, etc.), and a portable charger unit, into the docking station. In one embodiment, the docking station includes a control system to maintain safety and communication between energy storages, power electronics, and the electric vehicles, during electric charging. In one or more implementations, a user interface is provided on the docking station to, for instance, facilitate reporting parameters such as temperature, power metering, and any charging errors, etc.

In one or more embodiments, the docking station is configured to allow docking of one or more DC charger units to provide DC power to an electric vehicle (EV) battery. The docking station can include, in one implementation, one or more AC-to-DC converters to facilitate charging an electric vehicle, or charging one or more energy storage units. Further, in one or more embodiments, the docking station can include one or more DC-to-AC converters, for instance, to facilitate discharging one or more energy storage units to an AC power grid, when the electric vehicle charging system is connected to an AC grid. In one or more embodiments, the docking station can include isolation transformers to convert three-phase grid power to single-phase power to facilitate charging of a load, such as an electric vehicle battery.

In one or more embodiments, the docking station can include an electrical interlock system (or mechanism) which detects presence of, for instance, an energy storage unit or charger unit being docked into the docking station when physical contact is made. In one embodiment, the docking station, as well as the electrical interlock mechanisms, are configured for multiple energy storage units and/or multiple charger units to be docked into the station, or to be swappable, if desired. In one embodiment, the interlock mechanisms lock the energy storage unit(s) and/or charger unit(s) in place when operatively coupled within the docking station to, for instance, prevent unauthorized removal of the unit(s) from the docking station.

In one or more embodiments, such as depicted in FIG. 4A, the docking station can provide electric charge from one or more internal energy storage units and/or one or more docked energy storage units.

In one or more embodiments, the docking station includes control (or control code) implemented in hardware and/or software to, for instance, facilitate connecting multiple energy storage components in parallel, or in-series, to vary the power supply configurations available for charging a load, such as an electric vehicle battery. In addition, the control code can facilitate communication, such as wireless communication over one or more networks, such as one or more cellular networks, local-area networks (LANs), wide-area networks (WANs), etc., whether licensed or unlicensed, to one or more remote servers, such as one or more remote application servers.

In one or more embodiments, the docking station is configured to charge an electric vehicle and one or more energy storage units simultaneously from an AC power source.

In one or more embodiments, the electric vehicle charging system, and in particular, the docking station, is configured to allow charging of one or more energy storage units. In one or more embodiments, the docking station is configured to provide electric charge to one or more electric vehicles, such as one or more electric vehicle batteries, simultaneously if desired.

In one or more embodiments, the docking station is configured to facilitate discharging of one or more energy storage units, for instance, back into an AC power grid to which the docking station is electrically connected. For instance, in one or more embodiments, the docking station can convert DC power from one or more energy storage units to AC power to send from the energy storage unit(s) to the AC power grid, for instance, at times of high demand on the grid.

In one or more embodiments, the docking station is configured to allow charging of electric vehicle batteries at different charge levels (e.g., Level 1, Level 2, and/or Level 3 charging).

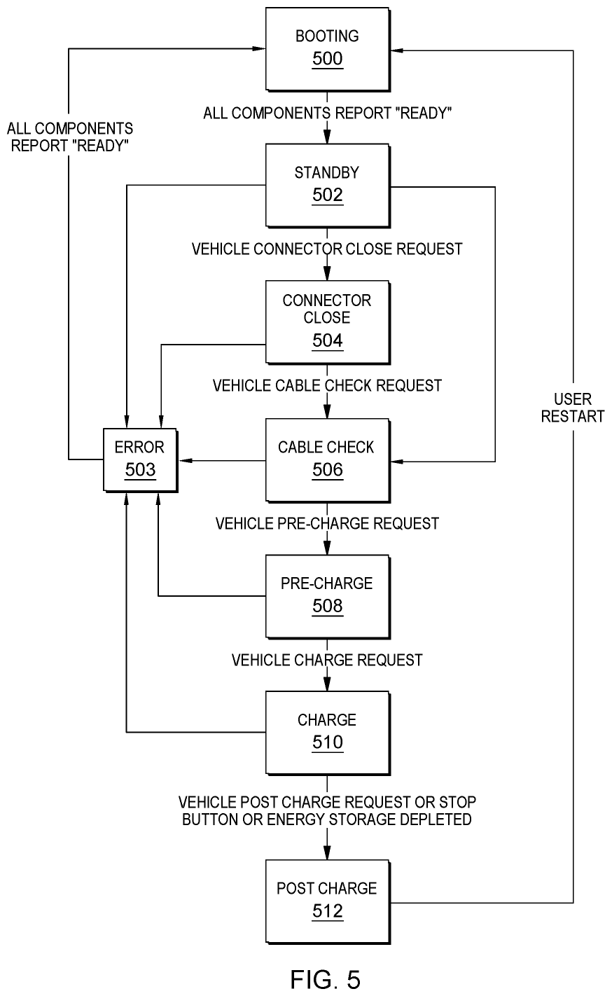

FIG. 5 depicts one embodiment of a workflow or charging state machine of the docking station when an energy storage unit and charger unit are connected and docked within the unit, and the charging cable is plugged into an electric vehicle for charging of an electric vehicle battery. The process begins with booting of the charging state machine 500, with all components reporting “READY”. A standby state 502 is entered until a vehicle connector (or contactor) close request is received, which transitions the state machine to connector close mode 504. If an error is reported during standby state 502 or connector close mode 504, an error state 503 is entered until all components again report a ready condition. From connector close mode 504, the state machine enters a cable check state 506 pursuant to a vehicle cable check request being made. From cable check state, the state machine enters a pre-charge state 508 based on a vehicle pre-charge request, and then a full charge state 510 is entered pursuant to a vehicle charge request, which assumes that there has not been an error in the check cable state 506 or pre-charge state 508. Assuming that the charge state 510 continues without error, then charging continues until a vehicle post-charge request is received, or a STOP button is activated, or an energy storage unit is depleted, which transitions the machine to a post-charge state 512. Note that FIG. 5 depicts one embodiment only of a charging state machine which can be implemented by an electric vehicle charging system, such as described herein.

FIGS. 6A-6B illustrate another embodiment of an electric vehicle charging system 600, in accordance with one or more aspects of the present invention. In one or more aspects, electric vehicle charging system 600 is similar to the electric vehicle charging systems described above in connection with FIGS. 1A-5. In the embodiment of FIGS. 6A-6B, the docking station 601 is a container-type docking station, such as a shipping-container-sized docking station, sized to accommodate multiple energy storage units 200″ and multiple charger units 210″ within container-type docking station 601, with an end door or sidewall of the docking station being removed to illustrate, for instance, one internal embodiment of the container-type docking station. In one or more embodiments, docking station 601 is a weather-proof enclosure sized to house components of electric vehicle charging system 600. As disclosed herein, certain of these components can be portable components including, for instance, the energy storage unit(s) 200″ and the one or more charger units 210″, such as one or more DC charger units. In one or more implementations, the energy storage unit(s) are one or more swappable, portable energy storage units, and the charger units are one or more swappable, portable charger units. In one or more embodiments, one or more doors (not shown) can be provided in the container-type docking station to facilitate, for instance, docking or removal of a portable energy storage unit and/or a portable charging unit from the docking station. In one or more embodiments, the swappable, portable energy storage units and/or swappable, portable charger units are positioned along opposite sides of container-type docking station to, for instance, facilitate docking and undocking of the units for swapping in/out, as needed.

As illustrated, the electric vehicle charging system 600 embodiment of FIGS. 6A-6B includes, for instance, multiple charging port cables 405, and respective user interface display screens 105 to provide respective charging of multiple electric vehicles when connected to the electric vehicle charging system.

In the embodiment of FIGS. 6A-6B, electric vehicle charging system 600 includes one or more solar panels, or photovoltaic arrays, that produce direct current (DC) electricity which can be used to charge, for instance, an internal energy storage 611, similar to internal energy storage 400 described above in connection with FIGS. 4A-4B. In one or more other embodiments, the DC electricity generated by the one or more solar panels 610 can also be used to charge one or more of the docked energy storage units 200″, if desired. Further, in one or more other embodiments, where the docking station is electrically connected to an AC grid, generated power from the solar panels can be converted to AC power and supplied to the power grid, for instance, in the case where the internal energy storage unit and docked energy storage units are fully charged.

In the embodiment of FIGS. 6A-6B, a cooling system is illustrated which includes one or more air-handling ducts 620 coupled to energy storage units 200″ and to charger units 210″, with the units including respective air-moving devices 621, 622, to facilitate removal of heat from the units. In one or more embodiments, container-type docking station 601 can include an air-conditioner to facilitate removal of heat from the energy storage units and charger units, as well as cooling of the interior of docking station 601.

As noted, FIG. 7 illustrates one embodiment of a safety monitoring system 700 for a docking station of an electric vehicle charging system, such as described herein, for instance, with reference to FIGS. 6A-6B, in one example. In one or more embodiments, safety monitoring system 700 is configured to monitor for a potential fault associated with the electric vehicle charging system, such as within, for instance, a container-type docking station 601. In the embodiment illustrated, the electric vehicle charging system includes, in addition to safety monitoring system 700, one or more detectors and/or sensors such as, for instance, one or more smoke detectors 701, one or more off-gas detectors 702, and/or one or more temperature sensors 703, etc., as well as multiple energy storage units 200″ and multiple charger units 210″, in one example. Safety monitoring system 700 is operatively coupled in communication with energy storage units 200″ and charger units 210″ using, for instance, a controller area network (CAN) protocol, Ethernet, or other communication protocol or manner, to allow safety monitoring system 700 to collect operational status of the units and systems within the docking station 601 to further facilitate detecting any potential faults or issues. If a fault is triggered, such as an excessive temperature reading inside of the docking station, safety monitoring system 700 is configured to automatically shut down or disconnect one or more, or all, of the operative systems and units within the docking station, for instance, by disconnecting the one or more systems or units using an emergency power-OFF (EPO) system 710 connected to the one or more systems or units within the docking station protected by the safety monitoring system.

Those skilled in the art will note from the description provided, that disclosed herein are electric vehicle charging systems. In one embodiment, the electric vehicle charging system includes an energy storage unit and a docking station. The docking station is sized to accommodate the energy storage unit within the docking station in a docked position, and the docking station includes an energy storage docking receptacle to operatively couple the energy storage unit to the docking station in the docked position. The electric vehicle charging system is configured to advantageously facilitate charging an electric vehicle battery from energy stored in the energy storage unit.

In the foregoing, and/or alternative, system embodiments, the energy storage unit includes a swappable, portable energy storage unit. The swappable, portable energy storage unit advantageously allows for ready replacement of the energy storage unit within the docking station, for instance, upon depletion of the energy stored within the energy storage unit.

In any of the foregoing, and/or alternative, system embodiments, the energy storage unit is one energy storage unit of multiple energy storage units docked within the docking station via respective energy storage docking receptacles of the docking station. With the multiple energy storage units docked within the docking station, the electric vehicle charging system facilitates charging the electric vehicle battery, and/or charging multiple electric vehicle batteries.

In any of the foregoing, and/or alternative, system embodiments, the electric vehicle charging system further includes a portable DC charger unit, with the docking station being sized to accommodate the portable DC charger unit therein in a docked position. In addition, the docking station includes a charger docking receptacle to operatively couple the portable DC charger unit to the docking station in the docked position. Advantageously, the swappable, portable energy storage unit and the portable DC charger unit docked within the docking station can be readily replaced, for instance, with depletion of energy stored in the portable energy storage unit, or detecting a defect or other issue with either the portable energy storage unit or the portable DC charger unit.

In any of the foregoing, and/or alternative, system embodiments, the docking station is configured to accommodate docking of multiple DC charger units therein to facilitate DC charging of the electric vehicle battery. With multiple DC charger units operatively docked within the docking station, multiple electric vehicle batteries can be charged concurrently from the docking station, and/or different portable DC charger units can provide different DC charging levels for charging the same or different electric vehicle batteries.

In any of the foregoing, and/or alternative, system embodiments, the energy storage docking receptacle includes a first interlock mechanism, and the charger docking receptacle includes a second interlock mechanism, where the first and second interlock mechanisms respectively lock the energy storage unit and the portable DC charger unit in docked position within the docking station when operatively coupled thereto. Advantageously, the first and second interlock mechanisms enhance safety of the electric vehicle charging system by, for instance, ensuring operative docking of the energy storage unit and the portable DC charger unit in locked position within the docking station.

In any of the foregoing, and/or alternative, system embodiments, the docking station further includes a control to control DC power transfer through the docking station between the energy storage unit and the portable DC charger unit. Advantageously, the control is configured to control DC power transfer through the docking station between the energy storage unit and the portable DC charger unit to ensure operation of the electric vehicle charging system, for instance, within specified operational parameters.

In any of the foregoing, and/or alternative, system embodiments, the docking station further includes an operator interface to allow an operator to selectively release one or more of the first and second interlock mechanisms locking the energy storage unit and the portable DC charger unit to the docking station. By providing the operator interface to allow the operator to selectively release one or more of the first and second interlock mechanisms, the energy storage unit and/or portable DC charger unit can be released and removed from docked position within the docking station, for instance, for replacing either the energy storage unit or the portable DC charger unit, as desired.

In any of the foregoing, and/or alternative, system embodiments, the docking station can be operatively coupled to an AC power source, and the electric vehicle charging system charges the electric vehicle battery using one or more of the energy storage unit or the AC power source. In this manner, the docking station can be a grid-less docking station, with no connection, for instance, to an AC power source, while in one or more other embodiments, the docking station can include connection to an AC power source, such as an underground electric connection to an AC power grid. In this manner, the docking station can be operational at a desired location for a period of time as a DC energy charger before, for instance, connection of the docking station to an AC power source, if desired.

In any of the foregoing, and/or alternative, system embodiments, the docking station can be operatively coupled to an AC power source, and the docking station further includes a control and one or more AC-to-DC converters to facilitate charging, using the AC power source, one or more of the electric vehicle battery or the energy storage unit. In this manner, the AC power source can supply power to the electric vehicle battery and/or the energy storage unit.

In any of the foregoing, and/or alternative, system embodiments, the docking station further includes one or more DC-to-AC converters to facilitate discharging of energy from one or more of the electric vehicle battery or the energy storage unit to the AC power source. In this manner, power can be supplied back to the AC power source from the electric vehicle battery and/or the energy storage unit.

In any of the foregoing, and/or alternative, system embodiments, the docking station can be operatively coupled to an AC power source, and include one or more isolation transformers to convert three-phase AC power of the AC power system to single-phase AC power to facilitate charging the electric vehicle battery by the electric vehicle charging system. In this manner, in one embodiment, the electric vehicle battery can undergo AC charging, such as Level 2 AC charging, commensurate with another electric vehicle battery undergoing, for instance, Level 3 DC charging, as one example.

In any of the foregoing, and/or alternative, system embodiments, the electric vehicle charging system further includes a safety monitoring system disposed within the docking station to monitor for a fault, and to shut down, at least in part, the electric vehicle charging system based on detecting the fault. Advantageously, the safety monitoring system protects users of the docking station, as well as components of the docking station by, for instance, monitoring for a potential fault associated with the electric vehicle charging system, and upon detection of one or more faults, to automatically shut down or disconnect one or more, or all, of the operative systems and units within the docking station, for instance, by disconnecting one or more systems or units using an emergency power OFF system connected to one or more systems or units within the docking station protected by the safety monitoring system.

In another embodiment, the electric vehicle charging system includes multiple energy storage units, a charger unit, and a docking station. The docking station is sized to accommodate the multiple energy storage units and the charger unit, each in a respective docked position within the docking station. Further, the docking station includes multiple energy storage docking receptacles to operatively couple respective energy storage units of the multiple energy storage units to the docking station in the docked position, and a charger docking receptacle to operatively couple the charger unit to the docking station in the docked position. Advantageously, the electric vehicle charging system is configured to facilitate, at least in part, charging an electric vehicle battery.

In the foregoing, and/or alternative, system embodiments, the electric vehicle charging system further includes a safety monitoring system disposed within the docking station to monitor for a fault, and to shut down, at least in part, the electric vehicle charging system based on detecting the fault. Advantageously, the safety monitoring system protects users of the docking station, as well as components of the docking station by, for instance, monitoring for a potential fault associated with the electric vehicle charging system, and upon detection of one or more faults, to automatically shut down or disconnect one or more, or all, of the operative systems and units within the docking station, for instance, by disconnecting one or more systems or units using an emergency power OFF system connected to one or more systems or units within the docking station protected by the safety monitoring system.

In a further embodiment, the electric vehicle charging system includes multiple energy storage units, multiple DC charger units, and a docking station sized to accommodate the multiple energy storage units and the multiple DC charger units, each in a respective docked position within the docking station. In an embodiment, the docking station is a container-type docking station, and includes multiple energy storage docking receptacles to operatively couple respective energy storage units of the multiple energy storage units to the docking station in the docked position, and multiple charger docking receptacles to operatively couple respective DC charger units of the multiple DC charger units to the docking station in the docked position. Advantageously, the electric vehicle charging system is configured to facilitate, at least in part, charging the electric vehicle battery.

In any of the foregoing, and/or alternative, system embodiments, the multiple energy storage units are multiple swappable, portable energy storage units, and the multiple DC charger units are multiple swappable, portable DC charger units. The swappable, portable energy storage units and the swappable portable DC charger units advantageously allow for ready replacement of, for instance, an energy storage unit within the docking station, for instance, upon depletion of the energy stored within the energy storage unit, and/or replacement of a DC charger unit upon, for instance, detecting a defect or other issue with the portable DC charger unit.

In any of the foregoing, and/or alternative, system embodiments, the docking station can be operatively coupled to an AC power source, and the electric vehicle charging system charges the electric vehicle battery using one or more of the multiple energy storage units or the AC power source. In this manner, the docking station can be operational at a desired location for a period of time as a DC energy charger before, for instance, connection of the docking station to an AC power source, if desired. Further, the electric vehicle charging system can optionally charge the electric vehicle battery using, for instance, energy stored in an energy storage unit of the multiple energy storage units, or power obtained from the AC power source.

In any of the foregoing, and/or alternative, system embodiments, the docking station further includes one or more DC-to-AC converters to facilitate discharging of energy from one or more of the electric vehicle battery or the multiple energy storage units to the AC power source. In this manner, power can be supplied back to the AC power source from the electric vehicle battery and/or the energy storage unit.

In any of the foregoing, and/or alternative, system embodiments, the electric vehicle charging system further includes a safety monitoring system disposed within the docking station to monitor for a fault, and to shut down, at least in part, the electric vehicle charging system based on detecting the fault. Advantageously, the safety monitoring system protects users of the docking station, as well as components of the docking station by, for instance, monitoring for a potential fault associated with the electric vehicle charging system, and upon detection of one or more faults, to automatically shut down or disconnect one or more, or all, of the operative systems and units within the docking station, for instance, by disconnecting one or more systems or units using the emergency power OFF system connected to one or more systems or units within the docking station protected by the safety monitoring system.

By way of further example, FIG. 8 depicts a computer system 800, or control, in communication with external device(s) 812, which can be used to implement one or more aspects disclosed herein. Computer system 800 includes one or more processor(s)802, for instance central processing unit(s) (CPUs). A processor can include functional components used in the execution of instructions, such as functional components to fetch program instructions from locations such as cache or main memory, decode program instructions, and execute program instructions, access memory for instruction execution, and write results of the executed instructions. A processor 802 can also include one or more registers to be used by one or more of the functional components. Computer system 800 also includes a memory 804, input/output (I/O) devices 808, and I/O interfaces 810, which may be coupled to processor(s) 802 and each other via one or more buses and/or other connections. Bus connections represent one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and Peripheral Component Interconnect (PCI).

Memory 804 can be, or include, main or system memory (e.g. Random Access Memory) used in the execution of program instructions, a storage device(s) such as hard drive(s), flash media, or optical media as examples, and/or cache memory, as examples. Memory 804 can include, for instance, a cache, such as a shared cache, which may be coupled to local caches (examples include L1 cache, L2 cache, etc.) of processor(s) 802. Additionally, memory 804 can be, or include, at least one computer program product having a set (e.g., at least one) of program modules, instructions, code or the like that is/are configured to carry out functions of embodiments described herein when executed by one or more processors.

Memory 804 can store an operating system 805 and other computer programs 806, such as one or more computer programs/applications that execute to perform aspects described herein. Specifically, programs/applications can include computer readable program instructions that can be configured to carry out functions of embodiments of aspects described herein.

Examples of I/O devices 808 include but are not limited to microphones, speakers, Global Positioning System (GPS) devices, cameras, lights, accelerometers, gyroscopes, magnetometers, sensor devices configured to sense proximity, temperature, etc. An I/O device can be incorporated into the computer system as shown, though in some embodiments an I/O device can be regarded as an external device (812) coupled to the computer system through one or more I/O interfaces 810.

Computer system 800 can communicate with one or more external devices 812 via one or more I/O interfaces 810. Example external devices include a keyboard, a display, one or more data sensors, and/or any other devices or control systems that (for instance) enable a user or other system to interact with computer system 800. Other example external devices include any device that enables computer system 800 to communicate with one or more other computing systems or peripheral devices. A network interface/adapter is an example I/O interface that enables computer system 800 to communicate with one or more networks, such as a local area network (LAN), a general wide area network (WAN), and/or a public network (e.g., the Internet), providing communication with other computing devices or systems, storage devices, or the like. Ethernet-based (such as Wi-Fi) interfaces and Bluetooth® adapters are just examples of the currently available types of network adapters used in computer systems. (BLUETOOTH® is a registered trademark of Bluetooth SIG, Inc., Kirkland, Washington, U.S.A.)

Communication between I/O interfaces 810 and external devices 812 can occur across wired and/or wireless communications link(s) 811, such as Ethernet-based wired or wireless connections. Example wireless connections include cellular, Wi-Fi, Bluetooth®, proximity-based, near-field, or other types of wireless connections. More generally, communications link(s) 811 can be any appropriate wireless and/or wired communication link(s) for communicating data between systems and/or devices to facilitate one or more aspects disclosed herein.

A particular external device(s) 812 can include one or more data storage devices, which can store one or more programs, one or more computer readable program instructions, and/or data, etc. Computer system 800 can include and/or be coupled to and in communication with (e.g., as an external device of the computer system) removable/non-removable, volatile/non-volatile computer system storage media. For example, it can include and/or be coupled to a solid-state device (SSD), or other non-volatile media, to store data persistently.

Computer system 800 can be operational with numerous other general purpose or special purpose computing system environments or configurations. Computer system 800 can take any of various forms, well-known examples of which include, but are not limited to, personal computer (PC) system(s), server computer system(s), thin client(s), thick client(s), workstation(s), laptop(s), handheld device(s), mobile device(s)/computer(s), such as smartphone(s), tablet(s), multiprocessor system(s), microprocessor-based system(s), network appliance(s) (such as edge appliance(s)), virtualization device(s), storage controller(s), programmable electronic(s), network PC(s), minicomputer system(s), mainframe computer system(s), and distributed cloud computing environment(s) that include any of the above systems or devices, and the like.

As will be appreciated by one skilled in the art, control aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, control aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable signal medium may be any non-transitory computer readable medium that is not a computer readable storage medium and that can communicate, propagate, or transport a program for use by or in connection with an instruction execution system, apparatus or device.

A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), a solid-state device (SSD), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

In one example, a computer program product includes, for instance, one or more computer readable storage media to store computer readable program code means or logic thereon to provide and facilitate one or more aspects of the present invention.

Program code embodied on a computer readable medium may be transmitted using an appropriate medium, including but not limited to wireless, wireline, optical fiber cable, RF, etc., or any suitable combination of the foregoing.

Computer program code for carrying out control and/or calibration operations for aspects of the present invention may be written in any combination of one or more programming languages, including an object oriented programming language, such as Java, Smalltalk, C++ or the like, and conventional procedural programming languages, such as the “C” programming language, assembler or similar programming languages. The program code may execute entirely on the user's computer, partly on the user's computer, on the user's personal device (e.g., phone, tablet, wearable), as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to block diagrams of methods, apparatus (systems) and computer program products according to embodiments of the invention. It will be understood that the control block of the diagram can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus (e.g., mobile device/phone), or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The block diagram in the figure illustrates the architecture, functionality, and operation of possible implementations of systems, methods and computer program products according to various embodiments of the present invention. In this regard, one or more blocks in the diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that one or more blocks of the diagram can be implemented by special purpose hardware-based systems that perform the specified functions or acts, or combinations of special purpose hardware and computer instructions.

In addition to the above, one or more aspects of the present invention may be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider may receive payment from the customer under a subscription and/or fee agreement, as examples. Additionally or alternatively, the service provider may receive payment from the sale of advertising content to one or more third parties.

In one aspect of the present invention, an application may be deployed for performing one or more aspects of the present invention. As one example, the deploying of an application comprises providing computer infrastructure (including, e.g., internet/cloud/IOT resources and/or a mobile device) operable to perform one or more aspects of the present invention.

As a further aspect of the present invention, a computing infrastructure may be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system may be provided. The computer system comprises a computer readable medium, in which the computer medium comprises one or more aspects of the present invention. The code in combination with the computer system is capable of performing one or more aspects of the present invention.

A popular type of computing is cloud computing, in which resources can interact and/or be accessed via a communications system, such as a computer network. Resources can be software-rendered simulations and/or emulations of computing devices, storage devices, applications, and/or other computer-related devices and/or services run on one or more computing devices, such as a server. For example, a plurality of servers can communicate and/or share information that can expand and/or contract across servers depending on an amount of processing power, storage space, and/or other computing resources needed to accomplish the requested task.

Cloud computing can be provided as a service over the Internet, such as in the form of “Infrastructure as a Service” (IaaS), “Platform as a Service” (PaaS), and/or “Software as a Service” (SaaS). IaaS can typically provide physical or virtual computing devices and/or accessories on a fee-for-service basis, and onto which clients/users can load and/or install, and management, platforms, applications, and/or data. PaaS can deliver a computing platform and solution stack as a service, such as, for example, a software development platform, application services, such as team collaboration, web service integration, database integration, and/or developer community facilitation. SaaS can deploy software licensing as an application to customers for use as a service on-demand. SaaS software vendors can host the application on their own clouds, or download such applications from clouds to cloud clients, disabling the applications after use, or after an on-demand contract expires.

The provision of such services allows a user access to as much in the way of computing resources as a user needs without purchasing and/or maintaining the infrastructure, such as hardware and/or software, that would be required to provide the services. For example, a user can instead obtain access via subscription, purchase, and/or otherwise securing access. Thus, cloud computing can be a cost-effective way to delivery information technology services.

Although various embodiments are described above, these are only examples. For example, computing environments of other architectures can incorporate and use one or more aspects of the present invention. Additionally, the network of nodes can include additional nodes, and the nodes can be the same or different from those described herein. Also, many types of communications interfaces may be used.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, mobile device/phone, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to explain the principles of the invention and the practical application, and to enable others of ordinary skill in the art to understand the invention through various embodiments and the various modifications thereto which are dependent on the particular use contemplated.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. An electric vehicle charging system comprising:
an energy storage unit;
a docking station sized to accommodate the energy storage unit therein in a docked position; and
the docking station including an energy storage docking receptacle to operatively couple the energy storage unit to the docking station in the docked position, wherein the electric vehicle charging system facilitates charging an electric vehicle battery.

2. The electric vehicle charging system of claim 1, wherein the energy storage unit comprises a swappable, portable energy storage unit.

3. The electric vehicle charging system of claim 2, wherein the energy storage unit is one energy storage unit of multiple energy storage units docked within the docking station via respective energy storage docking receptacles of the docking station.

4. The electric vehicle charging system of claim 2, further comprising a portable DC charger unit, the docking station being further sized to accommodate the portable DC charger unit therein in a docked position, and the docking station including a charger docking receptacle to operatively couple the portable DC charger unit to the docking station in the docked position.

5. The electric vehicle charging system of claim 4, wherein the docking station is configured to accommodate docking of multiple DC charger units therein to facilitate DC charging of the electric vehicle battery.

6. The electric vehicle charging system of claim 4, wherein the energy storage docking receptacle comprises a first interlock mechanism, and the charger docking receptacle comprises a second interlock mechanism, the first and second interlock mechanisms respectively locking the energy storage unit and the portable DC charger unit in docked positions within the docking station when operatively coupled thereto.

7. The electric vehicle charging system of claim 6, wherein the docking station further comprises a control to control DC power transfer through the docking station between the energy storage unit and the portable DC charger unit.

8. The electric vehicle charging system of claim 6, wherein the docking station further comprises an operator interface to allow an operator to selectively release one or more of the first and second interlock mechanisms locking the energy storage unit and the portable DC charger unit to the docking station.

9. The electric vehicle charging system of claim 1, wherein the docking station can be operatively coupled to an AC power source, and the electric vehicle charging system charges the electric vehicle battery using one or more of the energy storage unit or the AC power source.

10. The electric vehicle charging system of claim 1, wherein the docking station can be operatively coupled to an AC power source, and the docking station further comprises a control and one or more AC-to-DC converters to facilitate charging, using the AC power source, one or more of the electric vehicle battery or the energy storage unit.

11. The electric vehicle charging system of claim 10, wherein the docking station further comprises one or more DC-to-AC converters to facilitate discharging of energy from one or more of the electric vehicle battery or the energy storage unit to the AC power source.

12. The electric vehicle charging system of claim 1, wherein the docking station can be operatively coupled to an AC power source, and includes one or more isolation transformers to convert three-phase AC power of the AC power source to single-phase AC power to facilitate charging the electric vehicle battery by the electric vehicle charging system.

13. The electric vehicle charging system of claim 1, further comprising a safety monitoring system disposed within the docking station to monitor for a fault, and to shut down, at least in part, the electric vehicle charging system based on detecting the fault.

14. An electric vehicle charging system comprising:
multiple energy storage units;
a charger unit;
a docking station sized to accommodate the multiple energy storage units and the charger unit, each in a respective docked position within the docking station; and
the docking station including multiple energy storage docking receptacles to operatively couple respective energy storage units of the multiple energy storage units to the docking station in the docked position, and a charger docking receptacle to operatively couple the charger unit to the docking station in the docked position, wherein the electric vehicle charging system facilitates, at least in part, charging an electric vehicle battery.

15. The electric vehicle charging system of claim 14, wherein the electric vehicle charging system further includes a safety monitoring system disposed within the docking station to monitor for a fault, and to shut down, at least in part, the electric vehicle charging system based on detecting the fault.

16. An electric vehicle charging system comprising:
multiple energy storage units;
multiple DC charger units;
a docking station sized to accommodate the multiple energy storage units and the multiple DC charger units, each in a respective docked position within the docking station, wherein the docking station is a container-type docking station; and
the docking station including multiple energy storage docking receptacles to operatively couple respective energy storage units of the multiple energy storage units to the docking station in the docked position, and multiple charger docking receptacles to operatively couple respective DC charger units of the multiple DC charger units to the docking station in the docked position, wherein the electric vehicle charging system facilitates, at least in part, charging the electric vehicle battery.

17. The electric vehicle charging system of claim 16, wherein the multiple energy storage units are multiple swappable, portable energy storage units, and the multiple DC charger units are multiple swappable, portable DC charger units.

18. The electric vehicle charging system of claim 16, wherein the docking station can be operatively coupled to an AC power source, and the electric vehicle charging system charges the electric vehicle battery using one or more of the multiple energy storage units or the AC power source.

19. The electric vehicle charging system of claim 18, wherein the docking station further comprises one or more DC-to-AC converters to facilitate discharging of energy from one or more of the electric vehicle battery or the multiple energy storage units to the AC power source.

20. The electric vehicle charging system of claim 16, further comprising a safety monitoring system disposed within the docking station to monitor for a fault, and to shut down, at least in part, the electric vehicle charging system based on detecting the fault.
